(19) United States
(12) Patent Application Publication
(10) Pub. No.: US 2006/0140426 A1
(43) Pub. Date: Jun. 29, 2006

(54) Hearing protection device and use of such a device

(75) Inventor: Christian Berg, Uerikon (CH)

Correspondence Address: ROBERTS, MLOTKOWSKI & HOBBES, P. O. BOX 10064, MCLEAN, VA, 22102-8064, US

(73) Assignee: PHONAK AG, Staefa (CH)

(21) Appl. No.: 11/019,638

(22) Filed: Dec. 23, 2004

(51) Int. Cl. H04R 25/00

(52) U.S. Cl. 381/312; 381/328

(57) ABSTRACT

The invention relates to a hearing protection device comprising two earplugs (10, 12) to be worn at least in part in a user's right and left ear canal, respectively, and flexible means (14) for mechanically connecting the two earplugs, wherein at least one of said earplugs comprises an acoustic output transducer (32), wherein said connecting means comprises an antenna (24), wherein at least one of said earplugs comprises an electromagnetic signal receiving unit (26) electrically connected to said antenna and to said output transducer, and wherein said hearing protection device is adapted for wireless electromagnetic communication with a remote unit (36, 38, 40) via said antenna.

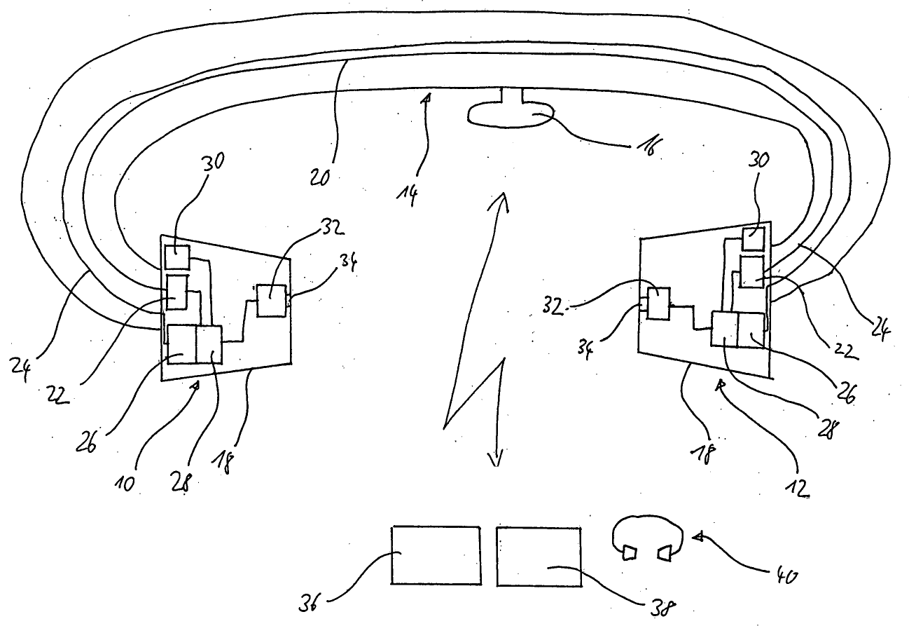

### BACKGROUND OF THE INVENTION

1. Field of the Invention

The present invention relates to a hearing protection device comprising two earplugs to be worn at least in part in a user's right and left ear canal, respectively, and flexible means for mechanically connecting the two earplugs, wherein at least one of the earplugs comprises an acoustic output transducer or a microphone.

2. Description of Related Art

U.S. Pat. No. 5,426,719 relates to a hearing protection device comprising two customized earplugs which both are connected via a respective wiring to an electronic module worn below the user's chin. One of the earplugs includes a speaker while the other earplug includes a microphone. The electronic module contains electronic components such as a power supply, a microphone preamplifier, equalization circuitry and radio receiver and transmitter. An antenna for radio frequency reception and transmission of speech is included in the wiring connecting the earplugs to the electronic module. The system is designed for allowing acoustic communication between several workers wearing the earplugs by radio frequency communication via the antenna included in the wiring.

DE 101 17 705 A1 relates to a hearing protection device including a combination of earmuffs and earplugs. The earplugs include a speaker, while the earmuffs include a microphone and an electronic unit for providing an active hearing protection function. The microphone and the speaker are coupled by coils. In addition, the electronic unit may be connected to a radio frequency antenna which may be integrated in the headband connecting the earmuffs in order to connect the electronic unit to a radio frequency transmitter for external communication purposes, such as connection to a phone system.

WO 01/66054 A1 relates to a wireless headset wherein the headband of the earmuffs includes an antenna.

It is an object of the invention to provide for a hearing protection device comprising two earplugs which, in addition to the hearing protection function, provides for a communication function but nevertheless has a compact and simple mechanical construction. It is a further object of the invention to provide for a hearing protection device comprising two earplugs which, in addition to the hearing protection function, provides for a binaural communication function while having a compact and simple mechanical construction. It is another object of the invention to provide for a corresponding use of such hearing protection devices.

### SUMMARY OF THE INVENTION

According to the invention, these objects are achieved by hearing protection devices as defined in claims 1, 17 and 25, respectively and a use of such hearing protection devices as defined in claims 26, 28 and 29, respectively.

The invention in general is beneficial in that by integrating an antenna or a binaural communication link into the flexible means for mechanically connecting the two earplugs, the earplugs are provided with an added communication function without the need for additional mechanical parts. The invention is further beneficial in that, by integrating an electromagnetic signal receiving unit or electromagnetic signal transmitting unit necessary for communication via the antenna, or electronic communication means necessary for establishing communication via the binaural communication link, into at least one of the earplugs, the complete minimum arrangement necessary for the desired communication is provided within the hearing protection device without additional external elements being necessary. Thereby the invention provides for particularly compact hearing protection devices having an added communication function.

The solution according to claims 1 and 26 is particularly useful if speech or other sound signal perception by the user is desired in a noisy environment which requires the use of a hearing protection device.

The solution according to claims 25 and 29 is particularly useful if the user, in a noisy environment which requires the use of hearing protection devices, wants to provide a remote person with a speech signal.

The solution according to claims 17 and 28 is particularly useful if binaural perception of speech or sound signals is desired in a noisy environment which requires the use of a hearing protection device.

These and farther objects, features and advantages of the present invention will become apparent from the following description when taken in connection with the accompanying drawing which, for purposes of illustration only, show several embodiments in accordance with the present invention.

### BRIEF DESCRIPTION OF THE DRAWINGS

The single FIGURE shows a schematic view of an example of a hearing protection device according to the invention.

The invention generally relates to hearing protection devices comprising two hearing protection earplugs which are to be worn at least in part in the user's right and left ear canal, respectively, i.e. at least the distal part of one of the earplugs is to be worn in the user's right ear canal while the distal part of the other one of the earplugs is to be worn in the left ear canal. The two earplugs are mechanically connected by flexible means, for example a cord or a headband. Such mechanical connecting means are provided for keeping the earplugs together and to prevent them from being lost. Preferably the mechanical connection means comprises means for fastening the mechanical connection means, and hence the earplugs, at the user's clothing. This is particularly important in view of the fact that hearing protection devices usually are used in rough environments and/or in situations of stress and distraction of the user so that hearing protection devices are particularly susceptible to being lost. Preventing loss of hearing protection devices is of crucial importance in the food processing industry, where contamination of the processed materials by lost articles is to be strictly avoided.

According to the single figure, a right ear hearing protection earplug 10 is mechanically connected to a left ear hearing protection earplug 12 by a flexible mechanical connection element 14, such as a headband or a cord. The connection element 14 is provided with a fixing element 16 which serves for fastening the connection 14 to the user's clothing. The fixing element 16 may be designed, for example, as a clip.

Each earplug 10, 12 comprises a shell 18 having an outer surface which is shaped such that the earplug 10, 12 can be inserted into the user's ear canal in order to provide for a hearing protection function by providing for an acoustic attenuation of preferably at least 10 dB averaged over the audible frequency range when the earplug is worn by the user to protect the user from excessive levels of ambient sound.

The earplug may comprise an acoustic filter for adjusting the desired total acoustic attenuation or for adjusting the frequency dependent acoustic attenuation.

The shell preferably is a hard shell having an elasticity from shore D85 to D65 and preferably is made of polyamide. In order to achieve optimized fit of the shell within the user's outer ear and ear canal, the shell preferably has an outer surface individually shaped according to the measured shape of the user's outer ear and ear canal, i.e. the shell preferably has an individually customized outer shape. The shape of the user's outer ear and ear canal may be determined by direct three-dimensional scanning of the ear canal and the concha or by producing an impression of the ear canal and the concha which subsequently undergoes scanning. The scanning process may be carried out optically, preferably by laser scanning. The digital data obtained by the scanning process is then used to create the hard shell by an additive or incremental layer-by-layer build up process. Such processes are also known as “rapid prototyping”.

A preferred additive build-up process is a layer-by-layer laser sintering process of powder material, preferably polyamide powder. Such processes are also known as “selective laser sintering” (SLS). The basic principle therein is the repeated deposition of a thin layer of material on a surface, with the desired sectional shape then being stabilized, i.e. hardened, by laser action. An overview regarding such processes can be found, for example, in US 2003/0133583 A1 or U.S. Pat. No. 6,533,062 B1.

In order to allow the user to communicate while wearing the earplugs, the hearing protection device of the present invention is provided with active components. For example, one or both of the earplugs may be provided with a microphone for converting ambient sound into input audio signals, a digital processing unit for processing these input audio signals into output audio signals, and an acoustic output transducer for converting the output audio signals into sound to be perceived by the user when wearing the earplugs. Such a configuration is also known as an active hearing protection device which enables the user to perceive ambient sound, for example speech signals, in a controlled manner while wearing the hearing protection device. Usually, the total amplification provided by the microphone, the digital signal processing unit and the output transducer is negative.

According to one aspect of the invention, the connection 14 is provided with a binaural communication link 20 for enabling the electronic units of the two earplugs 10, 12 to exchange data via the communication link 20 in order to provide for a binaural hearing function. To this end, both earplugs 10, 12 are provided with an electronic communication unit 22 which is connected with the communication link 20 in order to exchange data between the two earplugs 10, 12. Preferably, the communication link 20 is an optical fibre connection or a wire connection integrated within the mechanical connection 14.

According to another aspect of the invention, one or both of the earplugs 10, 12 is provided with an electromagnetic signal receiving unit and/or an electromagnetic signal transmitting unit in order to allow for wireless electromagnetic communication of the hearing protection device with a remote unit via an antenna 24 integrated within the mechanical connection 14. Preferably the antenna, the receiving unit and/or the transmitting unit are adapted to operate at radio frequencies. The antenna may be designed as an inductive loop antenna.

According to a preferred embodiment, the hearing protection device is adapted for bidirectional wireless communication with the remote unit via the antenna. In this case, at least one of the earplugs will be equipped with a microphone in order to transmit speech signals produced by the user of the hearing protection device to the remote unit, which preferably is, in this case, an active hearing protection device worn by another user, so that the two users are able to communicate by speech with each other via the bidirectional wireless communication link. In this case, electromagnetic signals corresponding to speech signals sensed by the microphone are transmitted to the other user via the antenna of the hearing protection device, while speech signals sent from the hearing protection device of the other user are received via the antenna and can be perceived by the user via the speakers within the earplugs.

However, in some cases it might be desirable to equip the hearing protection device only for unidirectional wireless communication, for example, by providing a hearing protection system with speakers only or with microphones only.

The invention is not restricted to the case in which the remote unit is another hearing protection device. Rather, the remote unit, both in case of bidirectional or unidirectional communication, may be for example an audio signal source such as a mobile phone, a personal computer, a discman, an MP3 player, a CD player, a DVD player or a radio tuner or an audio signal source permanently installed in a building.

However, the wireless communication link via the antenna may be used not only for transmitting or receiving audio signals but also might be used for exchange of non-audio data. In this case, the remote unit may be used, for example, for programming or configuring a digital signal processing unit provided within at least one of the earplugs.

In the single figure an example is shown in which both earplugs 10, 12 are adapted for full bidirectional wireless communication with a remote unit and where in addition the two earplugs 10, 12 are connected by the binaural communication link 20 for achieving binaural functionality of the overall system.

According to the figure, each earplug 10, 12 is provided with a unit 22 for bidirectional electronic communication via the communication link 20, an electromagnetic signal receiving and transmitting unit 26 including a digital signal processing unit 28, a microphone 30 for converting ambient sound into input audio signals for the digital signal processing unit 28, and an output transducer (speaker) 32 which is acoustically connected to a sound outlet opening 34 provided at the distal end of the earplug 10, 12. The speaker 32 is provided with output audio signals from the digital signal processing unit 28 which receives input audio signals both from the microphone 30 and the receiving/transmitting unit 26. The receiving/transmitting unit 26 of each earplug is connected to the antenna 24 which may be common to both receiving/transmitting units 26.

Further, the figure schematically shows examples of the remote unit, such as a remote audio signal source 36 which may be a mobile device or which may be permanently installed in a building, a remote programming/configuring source 38 or a remote active hearing protection device 40 worn by another user.

A power source for the electronic components may be included within the earplugs 10, 12 or it may be provided externally, such as within the fixing element 16, wherein in the latter case corresponding power supply wires would be integrated within the mechanical connection 14 (not shown in the figure).

Optionally, the antenna 24 and the communication link 20 could be physically the same element, i.e. the antenna could also serve as the communication link between the earplugs 10, 12.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. A hearing protection device comprising two earplugs to be worn at least in part in a user's right and left ear canal, respectively, and flexible means for mechanically connecting said earplugs, wherein at least one of said earplugs comprises an acoustic output transducer, wherein said connecting means comprises an antenna, wherein at least one of said earplugs comprises an electromagnetic signal receiving unit electrically connected to said antenna and to said output transducer, and wherein said hearing protection device is adapted for wireless electromagnetic communication with a remote unit via said antenna.

2. The hearing protection device of claim 1, wherein said antenna and said receiving unit (26) are adapted to operate at radio frequencies.

3. The hearing protection device of claim 1, wherein said antenna is designed as an inductive loop antenna.

4. The hearing protection device of claim 1, wherein said receiving unit comprises a digital signal processing unit.

5. The hearing protection device of claim 1, wherein both of said earplugs comprise an acoustic output transducer.

6. The hearing protection device of claim 1, wherein both of said earplugs (comprise an electromagnetic signal receiving unit.

7. The hearing protection device of claim 1, wherein both of said earplugs comprise a digital signal processing unit.

8. The hearing protection device of claim 7, wherein both of said earplugs comprise a microphone for producing audio signals, said digital signal processing unit being adapted to process said audio signals as input to said output transducer.

9. The hearing protection device of claim 8, wherein a total amplification provided by said microphone, said digital signal processing unit and said output transducer is negative.

10. The hearing protection device of claim 1, wherein said hearing protection device is adapted for bidirectional wireless electromagnetic communication with said remote unit via said antenna.

11. The hearing protection device of claim 1, wherein at least one of said earplugs comprises an electromagnetic signal transmitting unit.

12. The hearing protection device of claim 11, wherein said electromagnetic signal transmitting unit is adapted to operate at radio frequencies.

13. The hearing protection device of claim 1, wherein said remote unit is an active hearing protection device worn by another user.

14. The hearing protection device of claim 1, wherein said remote unit is an audio signal source selected from the group consisting of a mobile phone, a personal computer, a discman, an MP3 player, a CD player, a DVD player, a radio tuner and an audio signal source permanently installed in a building.

15. The hearing protection device of claim 1, wherein said remote unit is selected from the group consisting of a unit for programming said digital signal processing unit and a unit for configuring said digital signal processing unit.

16. The hearing protection device of claim 1, wherein both of said earplugs comprise means for electronic communication and said mechanical connecting means comprises a binaural communication link for directly connecting said communication means of said two earplugs.

17. A hearing protection device comprising two earplugs to be worn at least in part in a user's right and left ear canal, respectively, and flexible means for mechanically connecting said earplugs, wherein both of said earplugs comprise an acoustic output transducer and means for electronic communication, and wherein said mechanical connecting means comprises a binaural communication link for directly connecting said communication means of said two earplugs.

18. The hearing protection device of claim 17, wherein said binaural communication link is an optical fiber connection or a wire connection integrated within said mechanical connection means.

19. The hearing protection device of claim 17, wherein each of said means for electronic communication comprises a digital signal processing unit.

20. The hearing protection device of claim 1, wherein said mechanical connection means is selected from the group consisting of a headband and a cord.

21. The hearing protection device of claim 1, wherein said mechanical connection means comprises means for fastening said mechanical connection means to said user's clothing.

22. The hearing protection device of claim 1, wherein each of said earplugs comprises a shell which is designed for achieving an acoustic attenuation of at least 10 dB averaged over an audible frequency range when worn by said user.

23. The hearing protection device of claim 1, wherein the outer surface of said shell is individually shaped according to a measured inner shape of said user's outer ear and ear canal.

24. The hearing protection device of claim 23, wherein said shell is a hard shell with an elasticity of from shore D85 to shore D65.

25. A hearing protection device comprising two earplugs to be worn at least in part in a user's right and left ear canal, respectively, and flexible means for mechanically connecting said earplugs, wherein at least one of said earplugs comprises a microphone, wherein said connecting means comprises an antenna, wherein at least one of said earplugs comprises an electromagnetic signal transmitting unit electrically connected to said antenna and to said microphone, and wherein said hearing protection device is adapted for wireless electromagnetic communication with a remote unit via said antenna.

26. A use of the hearing protection device of claim 1, comprising: inserting said earplugs into said user's ear canal for mechanically attenuating sound waves arriving at an outer end of each earplug by at least 10 dB averaged over an audible frequency range, establishing a wireless electromagnetic communication between said hearing protection device and said remote unit via said antenna, and providing acoustic signals to said user's ear via said at least one acoustic output transducer.

27. The use of claim 26, further comprising: at least one of programming and configuring a digital signal processing unit provided in at least one of said earplugs by signals from said remote unit via said antenna.

28. A use of the hearing protection device of claim 17, comprising: inserting said earplugs into said user's ear canal for mechanically attenuating sound waves arriving at an outer end of each earplug by at least 10 dB averaged over an audible frequency range, establishing communication between said communication means of said two earplugs via said binaural communication link, and providing acoustic signals to said user's ear via said acoustic output transducers.

29. A use of the hearing protection device of claim 25, comprising: inserting said earplugs into said user's ear canal for mechanically attenuating sound waves arriving at an outer end of each earplug by at least 10 dB averaged over an audible frequency range, establishing a wireless electromagnetic communication between said hearing protection device and said remote unit via said antenna, and providing audio signals generated by said microphone to said remote unit via said at least one acoustic output transducer.
